(19) United States
(12) Patent Application Publication
(10) Pub. No.: US 2014/0278851 A1
(43) Pub. Date: Sep. 18, 2014

(54) METHOD AND A TRUSTED SOCIAL NETWORK PLATFORM FOR FACILITATING PEER-TO-PEER SHIPMENT DELIVERY

(71) Applicant: VENKATA KRISHNA PRASAD KOPANATI, Fremont, CA (US)

(72) Inventor: VENKATA KRISHNA PRASAD KOPANATI, Fremont, CA (US)

(73) Assignee: Venkata Krishna Prasad Kopanati, Fremont, CA (US)

(21) Appl. No.: 14/201,908

(22) Filed: Mar. 9, 2014

Related U.S. Application Data
(60) Provisional application No. 61/776,989, filed on Mar. 12, 2013.
(60) Provisional application No. 61/950,171, filed on Mar. 9, 2014.

(51) Int. Cl. G06Q 50/00; G06Q 30/02

(52) U.S. Cl. CPC G06Q 50/01; G06Q 30/0208
USPC 705/14.11

(57) ABSTRACT

A method and a trusted social network platform (110) for facilitating peer-to-peer shipment delivery are disclosed. The trusted social network platform comprises a trip management module (202) configured to receive details of a trip of a trusted traveler, and a shipping information module (204) configured to receive a package shipment request from a trusted shipper. The trusted traveler and the trusted shipper have a pre-existing trust relationship through a trusted social network such that the trusted shipper is authorized to send one or more package shipment requests for the trusted traveler. The trusted social network platform also comprises a traveler-shipment matcher module (206) configured to match the package shipment request with the trusted traveler to facilitate peer-to-peer shipment delivery and a reward management module (208) configured to provide rewards to the trusted traveler and the trusted shipper.

### RELATED APPLICATION

This application claims the benefit of U.S. Provisional Application No. 61/776,989, entitled, “Connecting Travelers and Shippers over a Network and Facilitating Shipment Delivery Transactions”, to Venkata Krishna Prasad Kopanati, filed on Mar. 12, 2013, which is incorporated by reference herein for all that it teaches and discloses, as well as U.S. Provisional Application No. 61/950,171, entitled, “A Method and a Trusted Social Network Platform for Facilitating peer-to-peer Shipment Delivery”, to Venkata Krishna Prasad Kopanati, filed on Mar. 9, 2014, which is also incorporated by reference herein for all that it teaches and discloses.

### FIELD OF THE INVENTION

The present invention relates generally to social media networks and in particular to a trusted social network platform for facilitating peer-to-peer shipment delivery.

### BACKGROUND

Traditional package shipment delivery service providers, such as United Parcel Service (UPS), Federal Express (FedEx) and United States Postal Service (USPS) require the use of dedicated vehicles and dedicated staff. This results in an increase in energy consumption and wear-and-tear of the transportation infrastructure. Moreover, the cost of express delivery services, such as next day delivery by these traditional package shipment delivery service providers is usually very high.

There are some existing solutions that take advantage of excess capacity available in transportation systems, such as space in the private vehicles of commuting individuals, bicycles, pedestrians, public transit, private carriers, and the like. However, none of the existing solutions utilize the power of social media and a relationship of trust between members of the social media network to facilitate a peer-to-peer package shipment delivery. Moreover, the existing methods and systems for package shipment delivery do not provide formation of a trusted social network of travelers and shippers that enable features like providing reward points, rating and gaming options which could make the experience of package shipment delivery rewarding, exciting and fun for the shipper and the traveler.

### TERMS AND DEFINITIONS

Below are definitions of terms in the context of this document:

A “package shipment” is an item that requires transportation, including but not limited to packages, goods, documents etc.

A “trusted shipper” is a person or an entity who has package shipments to be transported. Typically the shipper could be an individual or a corporate organization that uses trusted travelers to transport package shipments.

A “trusted traveler” is a person who carries the package shipment from one location to another. The trusted traveler and the trusted shipper have a pre-existing trust relationship through a trusted social network such that the trusted shipper is authorized to send package shipment requests for the trusted traveler.

The terms “start location”, “start city”, “from location”, “from city”, “origin” are used interchangeably and refer to geographic location from where a trip of the trusted traveler begins.

The terms “end location”, “end city”, “to location”, “to city”, “destination” are used interchangeably and refer to location at which either the trip of the traveler ends or an intermediate location of the trip where the traveler can drop off or hand over the package shipment.

The terms “trip”, “journey”, “travel” are used interchangeably and refer to the act of travelling from one geographic location to another. A trip, journey or travel is typically characterized by a start date, end date, start location, end location, weight, and price.

A “user” may refer to either the trusted traveler or the trusted shipper.

A “shipping service” refers to an act of a transporting package shipments.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 is example block diagram that illustrates an environment 100 in accordance with an embodiment of the present invention;

FIG. 2 is an example block diagram illustrating the trusted social network platform 110 in accordance with an embodiment of the present invention;

FIG. 3 is a flow diagram illustrating a method 300 for facilitating peer-to-peer shipment delivery in a trusted social network, in accordance with an embodiment of the present invention;

FIG. 4 is a bock diagram of environment 400 depicting formation of the trusted social network in accordance with an embodiment of the present invention;

FIG. 5 is a block diagram that illustrates a mathematical formula for determining a Trust Score (TS) in accordance with an embodiment of the present invention;

FIG. 6 is a flow diagram illustrating a method 600 depicting formation of a trusted social network based on Trust Score (TS) in accordance with an embodiment of the present invention;

FIG. 7 is a block diagram illustrating an environment 700, in accordance with a second embodiment of the invention;

FIG. 8 is an example block diagram illustrating components of the shipping application 724 in accordance with an embodiment;

FIG. 9 is an exemplary block diagram illustrating a sign-up interface 900 in accordance with an embodiment;

FIG. 10 is an exemplary block diagram illustrating a user interface 1000 depicting submission of detail of a trip, in accordance with an embodiment;

FIG. 11 is a block diagram depicting user interface 1100 depicting selection of notification during submission of the detail of the trip, in accordance with an embodiment;

FIG. 12 is a block diagram illustrating notification summary interface 1200, in accordance with an embodiment;

FIG. 13 is a block diagram illustrating search interface 1300, in accordance with an embodiment.

FIG. 14 is a block diagram illustrating user interface 1400 for a package shipment request, in accordance with an embodiment;

FIG. 15 is a block diagram illustrating user interface 1500 for reviewing a selected trip, in accordance with an embodiment;

FIG. 16 is a block diagram illustrating a user interface 1600 for placing a package shipment request, in accordance with an embodiment;

FIG. 17 is a block diagram illustrating a user interface 1700 for accepting a package shipment request, in accordance with an embodiment;

FIG. 18 is block diagram of a user interface 1800 for accepting the package shipment request, in accordance with another embodiment;

FIG. 19 is a block diagram illustrating a user interface 1900 for providing payment details, in accordance with an embodiment;

FIG. 20 is a block diagram illustrating a user interface 2000 to review payment information in accordance with an embodiment; and

FIG. 21 is a block diagram illustrating a computer system 2100 where various embodiments of the present invention can be practiced.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and trusted social network platform for facilitating peer-to-peer shipment delivery, in accordance with various embodiments of the present invention, it should be observed that the present invention resides primarily in a trusted social network platform for facilitating peer-to-peer shipment delivery. In this document, the terms “comprises,” “comprising”, or any other variation thereof, are intended to cover a non-exclusive inclusion, such that a process, method, article or apparatus that comprises a list of elements does not include only those elements, but may include other elements that are not expressly listed or inherent in such a process, method, article or apparatus. An element proceeded by “comprises . . . a” does not, without more constraints, preclude the existence of additional identical elements in the process, method, article or apparatus that comprises the element.

The term “another,” as used in this document, is defined as at least a second or more. The terms “includes” and/or “having”, as used herein, are defined as comprising. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

### SUMMARY

Methods and a trusted social network platform for facilitating peer-to-peer shipment delivery are disclosed. In an embodiment, the trusted social network platform includes a trip management module configured to receive details of a trip of a trusted traveler and a shipping information module configured to receive a package shipment request from a trusted shipper. The trusted traveler and the trusted shipper have a pre-existing trust relationship through a trusted social network such that the trusted shipper is authorized to send package shipment requests for the trusted traveler. Typically, the trusted social network includes of the trusted traveler includes the trusted traveler and one or more trusted shippers. The trusted social network platform also includes a traveler-shipment matcher module configured to match the package shipment request with the trusted traveler to facilitate peer-to-peer shipment delivery and a reward management module configured to provide rewards to the trusted traveler. Typically, the rewards are based on one or more package shipments carried by the trusted traveler.

In an embodiment, the trusted social network platform includes a trust network module configured to manage the trusted social network. The trusted social network interconnects the trusted traveler and one or more trusted shippers. The trust network module further includes a social network interface module. The social network interface module is configured to provide interface with a plurality of social media networks and to facilitate formation of the trusted social network by utilizing social media connections of the trusted traveler and the trusted shipper.

In an embodiment, the trust network module includes a trust network creation module configured to create the trusted social network. The trust network module also includes a trust network management module configured to update, delete and manage profile of the trusted traveler and the trusted shipper.

Typically, the pre-existing trust relationship is based on a direct social association between the trusted traveler and the trusted shipper. The direct social association is established when the trusted traveler is directly connected with the trusted shipper through a social media network. The direct connection is established when there is one degree of separation between the trusted traveler and the trusted shipper in the social media network. In an alternate embodiment, the pre-existing trust relationship is based on an inherited association between the trusted traveler and the trusted shipper. The inherited association is established when the trusted traveler and the trusted shipper have an indirect connection through a social media network. The indirect connection is established when there is two or more degree of separation between the trusted traveler and the trusted shipper in the social media network. In an embodiment, the pre-existing trust relationship is a provisional trust relationship. The provisional trust relationship is established when the trusted traveler temporarily adds the trusted shipper to the trusted social network.

In an embodiment, a Trust Score (TS) is assigned to the trusted shippers and measures the level of trust relationship between the trusted traveler and the trusted shipper. Typically, the pre-existing trust relationship is established when a Trust Score (TS) of the trusted shipper is more than a predetermined value. The Trust Score is based at the least one of an organizational score (OS), a social score (SS), an affinity score (AS), a rating score (RS), a transaction score (TXS), and a profile score (PS). Typically, the Trust Score (TS) is based on weighted average of one or more of the organizational score (OS), the social score (SS), the affinity score (AS), the rating score (RS), the transaction score (TXS), and the profile score (PS). In this embodiment, the weighted average is based on at least one of weightage of the organizational score (WOS), weightage of the social score (WSS), weightage of the affinity score (WAS), weightage of the rating score (WRS), weightage of the transaction score (WTXS), and weightage of the profile score (WPS).

In an embodiment, the trip management module incudes a trip submission module configured to receive, validate and save details of the trip. Typically, details of the trip include at least one of, start location of the trusted traveler, start date of travel, end date of travel, end location of travel, and details of the package shipment. The trip management module also includes a trip search module configured to search trips based on input criteria and a trip selection module configured to select a trip to place one or more package shipment requests.

The trusted social network platform includes an account management module configured to manage member accounts of the trusted traveler and the trusted shipper. It also includes a payment management module configured to process payments and a ratings module configured to manage ratings of the trusted traveler and the trusted shipper. Typically, the trusted traveler is rated on the package shipment delivered by him and the trusted shipper is rated on the package shipment requested by him.

In an embodiment, the trusted social network platform includes a green credit module configured to determine green credits earned by the package shipment delivery. The green credits are based on the reduction in the energy usage achieved by the package shipment delivery facilitated by the trusted social network platform when compared to energy usage if the package shipment were delivered by a traditional shipment delivery service provider such as FedEx, UPS and USPS etc. Typically the green credits are carbon credits.

In an embodiment, the invention provides a method for facilitating peer-to-peer shipment delivery in a trusted social network. The method at a trusted social network platform includes receiving details of a trip of a trusted traveler. The method also includes receiving a package shipment request of a trusted shipper, wherein the trusted traveler and the trusted shipper have a pre-existing trust relationship through a trusted social network such that the trusted shipper is authorized to send package shipment requests for the trusted traveler. Typically, the trusted social network interconnects the trusted traveler and one or more trusted shipper. The method further includes matching the package shipment request with the trusted traveler to facilitate peer-to-peer shipment delivery and providing rewards to the trusted traveler and the trusted shipper. Typically, the rewards are based on one or more package shipments carried by the trusted traveler or the package shipment requests placed by the trusted shipper.

In an embodiment, the method includes facilitating formation of the trusted social network by utilizing one or more social media connections of the trusted traveler and the trusted shipper. The method further includes receiving details of the trip, validating the details of the trip, saving details of the trip, searching for the trip based on input criteria, and selecting the trip to place a package shipment request.

In an embodiment, the method includes managing member accounts of the trusted traveler and the trusted shipper, processing payments for the trusted traveler and the trusted shipper, and providing rating to the trusted traveler and the trusted shipper. In an embodiment, the method includes determining green credits earned by the package shipment delivery.

In an embodiment, the invention provides a computer storage device encoded with a computer program. The program comprising instructions that when executed by a computational device cause the computational device to perform operations. The operations include receiving details of a trip of a trusted traveler, receiving a package shipment request from a trusted shipper, wherein the trusted traveler and the trusted shipper have a pre-existing trust relationship through a trusted social network such that the trusted shipper is authorized to send package shipment requests for the trusted traveler, matching the package shipment request with the trusted traveler to facilitate peer-to-peer shipment delivery, and providing rewards to the trusted traveler wherein the rewards are based on one or more package shipments carried by the trusted traveler.

In an embodiment, the invention provides a trusted social network platform for facilitating peer-to-peer shipment delivery, the trusted social network platform includes a trust network module configured to manage a trusted social network, the trusted social network facilitating communication between a trusted traveler and a trusted shipper. The trusted traveler has a trust relationship with the trusted shipper such that the trusted shipper is pre-authorized to send package shipment requests for the trusted traveler. The social network platform also includes a trip management module configured to receive details of a trip of the trusted traveler and a shipping information module configured to receive details of a package shipment from the trusted shipper, a traveler-shipment matcher module configured to match the package shipment request with the trusted traveler to facilitate peer-to-peer shipment delivery, and a reward management module configured to provide rewards to the trusted traveler wherein the rewards are based on one or more package shipments carried by the trusted traveler.

Embodiments of the present invention provide a method and trusted social network platform that facilitate peer-to-peer shipment delivery, such as packages, documents, goods, or any other item that can be carried by the trusted traveler, by enabling trusted traveler and trusted shipper to interconnect through a trusted social network over a communication network (e.g. internet) to facilitate package shipment delivery. Accordingly, the present invention provides a method and a trusted social network platform that facilitates a cost-effective and convenient way for delivery of package shipments.

In an embodiment, the invention enables: 1) the trusted traveler to submit details of a trip 2) the trusted shipper to search for the trip 3) the trusted shipper to select the trip and place a package shipment request 4) the trusted traveler to receive a notification about the package shipment request 5) the trusted traveler to view the package shipment request and accept or reject it 6) the trusted shipper to receive notification about the trusted traveler's acceptance or rejection 7) the trusted shipper to submit a payment using a credit card upon acceptance of the package shipment request by the trusted traveler 8) the trusted shipper to deliver the package shipment at a specified address 9) the trusted traveler to pick up the shipment 10) the trusted shipper to track the package shipment 11) the trusted shipper to receive notification about delivery of the package shipment 12) the trusted traveler to receive payments upon delivery of the package shipment.

In an embodiment, the invention may provide contact information, such as email address, and physical address, for example, home address, office address, point-of-interest address or any other address specified by the trusted traveler, to the trusted shipper when the trusted traveler accepts the package shipment request. Accordingly, a trusted shipper may get the package shipment delivered at the address specified by the trusted traveler. Alternately, the trusted traveler may pick up the package shipment from the address specified by the trusted shipper.

In an embodiment, the invention enables a trusted traveler to set up a trusted social network by specifying criteria for accepting a trusted shipper to become a part of his trusted social network and thereby become trusted shipper of the trusted social network of the trusted traveler. The criteria could be trust between the trusted traveler and the trusted shipper. Typically, the trust is one of personal trust, and inherited trust.

Typically, when the trusted shipper meets the criteria, a trust relationship is established between the trusted traveler and the trusted shipper. In an embodiment, the trusted traveler may establish a personal trust with the trusted shipper that holds a direct social association with the trusted traveler. Typically, the direct social association is established when the trusted traveler has a direct connection with the trusted shipper through at least one social media network. Typically, the direct connection is established when there is one degree of separation between the trusted traveler and the trusted shipper in the social media network.

In another embodiment, the trusted traveler may establish an inherited trust with the trusted shipper. The inherited trust is based on an inherited social association between the trusted traveler and the trusted shipper. The inherited social association is established when the trusted traveler and the trusted shipper have an indirect connection through a social media network, for example through Facebook. This indirect connection is established when there is two or more degree of separation between the trusted traveler and the trusted shipper in the social media network. For example, the pre-existing trust relationship is established between trusted shipper A and a trusted traveler C when the trusted shipper A holds a trust relationship with a trusted shipper B and the trusted shipper B holds a direct relationship with the trusted traveler C. Here, A has two degree of separation with C. in this case A may establish a pre-existing trust relation with C because of inherited trust. Accordingly, a trusted social network of a trusted traveler includes the trusted traveler and one or more trusted shippers with whom the trusted traveler has a pre-existing trust relationship. Typically, the trusted social network includes trusted shippers that the trusted traveler has pre-existing trust relationship with, the relationship being so strong that the trusted traveler feels comfortable transporting package shipments for the trusted shipper.

In an embodiment, the trusted traveler may create the trusted social network when submitting details of the trip. The trusted traveler may select one or more trusted shippers, by providing email addresses or by selecting from one or more social media network such as Facebook, Twitter, etc. For example, a trusted traveler A may provide email addresses for trusted shippers S1, S2, and S3 (shipper1@gmail.com, shipper2@yahoo.com, and shipper3@hotmail.com respectively), select trusted shippers S10, S12, and S13 from Facebook (with Facebook unique user identification Shipper10, Shipper12 and Shipper13 respectively) and select trusted shippers S20, S21, and S22 from Twitter (with Twitter unique user identification Shipper20, Shipper21, and Shipper22 respectively). As a result, the trusted shippers S1, S2, S3, S10, S12, S13, S20, S21, and S22 may get added to the trusted social network of the trusted traveler A. In an alternate embodiment, the trusted shippers may also form his trust network which includes the trusted shipper and one or more trusted travelers.

In an embodiment, the trusted traveler may accept shipments from a trusted shipper that does not belong to the trusted social network of the trusted traveler. In this embodiment, the trusted shipper may become a member of trusted social network of the trusted traveler if the trusted traveler decides to deliver the package shipment of the trusted shipper. Typically, trusted shippers that do not belong to the trusted social network of the trusted traveler may also place package shipment request, but may need approval from the trusted traveler to become a part of the trusted social network of the trusted traveler. Typically, such trusted shippers may need to provide additional information to gain the trust of the trusted traveler. The additional information includes contents of the package, photographs of the contents of the package, contact information, recommendation by a trusted shipper that belongs to the trusted social network of the trusted traveler.

In an embodiment of the invention, a trusted shipper who is not a part of the trusted social network of the trusted traveler may deliver the package shipment via the trusted traveler. In this embodiment, the pre-existing trust relationship is a provisional trust relationship. The provisional trust relationship is established when the trusted traveler temporarily adds the trusted shipper to the trusted social network of the trusted traveler. Typically, the trusted traveler temporarily adds the trusted shipper to his trusted social network, accepts the trusted shipper's package shipment request, delivers the package shipment, and after successful delivery confirms the provisional addition of the trusted shipper. Once confirmed, the trusted shipper becomes a part of the trusted social network of the trusted traveler. In an embodiment, the trusted traveler may reject the package shipment request of the trusted shipper. In this case the trusted shipper will not be added to trusted social network of the trusted traveler.

In various embodiments, the trusted traveler is compensated for transporting the package shipment. Typically, the trusted traveler may provide a price of carrying the package shipment when submitting detail of the trip. In an embodiment, the trusted traveler may not get a monetary compensation for carrying package shipment.

Typically, the invention provides a method and system, such as the trusted social network platform for facilitating package shipment delivery. For example, a trusted traveler traveling from Sunnyvale, Calif. on Dec. 8, 2014 to Chicago, Ill. and reaching there on Dec. 9, 2014 may submit a trip where the starting city is Sunnyvale, Calif., ending city is Chicago, Ill., start date is Dec. 8, 2012 and delivery date is Dec. 9, 2012. If the trusted traveler desires to carry a maximum weight of 35 pounds the total weight will be 35 pounds. If the trusted traveler desires to charge $4.0 per pound of shipment the price per pound of shipment will be $4.0. Once the trusted traveler submits these details of the trip he may receive one or more package shipment requests. For example, the trusted traveler may receive four package shipment requests from multiple trusted shippers for transporting package shipments weighing 4 pounds, 20 pounds, 11 pounds and 6 pounds respectively. The trusted traveler may accept three of these package shipment requests, the request for 4 pounds, 20 pounds and 11 pounds, and may reject the fourth package shipment request for 6 pounds. The trusted shippers may eventually pay $16.00, $80.00 and $44.00. Accordingly, the trusted traveler may deliver all three shipments and receive a total payment of $140. In an embodiment, the trusted social network platform may provide recommendations to the trusted traveler about selection of the package shipment requests. Typically, the recommendations are based on criteria defined by the trusted traveler. An embodiment of the present invention enables the trusted traveler to compare prices from traditional shipping firms such as UPS, FedEx, and United States Postal Service (USPS) etc. Another embodiment of the invention provides a price recommendation module configured to recommend the price that the trusted traveler may be able to charge for the package shipment delivery. Typically, the price recommendation is based on at least one of from the group comprising the price charged by a traditional shipping firm for package shipment delivery, the date of travel, the duration of the trip, the size of the package shipment, the value of the package shipment, the mode of travel etc.

While various embodiments are disclosed, still variations of the embodiments of the present invention will become apparent to those skilled in the art from the following detailed description, which describes illustrative embodiments of the invention, or may be learned by practicing the invention as set forth hereinafter. As will be realized, the invention is capable of modifications in various aspects, all without departing from the scope of the present invention. Accordingly, the drawings and detailed description of the present invention are to be regarded as illustrative in nature and not restrictive.

Certain portions of this application, such as the Abstract and Summary, are provided to allow the reader to quickly ascertain the nature of the disclosure. They are submitted with the understanding that they will not be used to interpret or limit the scope or meaning of the claim.

FIG. 1 is example block diagram that illustrates an environment 100 in accordance with an embodiment of the present invention. The environment 100 includes a communication network 102. The communication network 102 may be geographically spread over an area, such as a building, a campus, a city, and so forth. Examples of the communication network 102 include a Local Area Network (LAN), a Metropolitan Area Network (MAN), a Wide Area Network (WAN) such as the Internet, and so forth. In any case, the communication network 102 can be a client-server network or a peer-to-peer network.

Regardless of the type, the communication network 102 has a plurality of communication devices associated with it. For example, the communication network 102 is shown to be associated with a first communication device 104, a second communication device 106, and a third communication device 108. Examples of the communication devices 104 to 108 include, but are not limited to, computers, tablets, cameras, laptops, personal digital assistants (PDAs), and mobile phones.

In addition to the communication devices 104 to 108, the communication network 102 is associated with a shipping platform, for example, a trusted social network platform 110. The trusted social network platform 110 facilitates peer-to-peer shipment delivery of package shipments by connecting a trusted traveler and a trusted shipper over the communication network 102. The communication network 102 is also associated with a social network server 112. The social network server 112 is a server hosting a social network application such as Facebook, LinkedIn, Twitter, or Google+ etc.

Typically, the trusted traveler and the trusted shipper use the social network platform 110 for peer-to-peer package shipment delivery. In an embodiment, the trusted traveler offers package shipment service to transport package shipments and a trusted shipper seeks package shipment delivery services to send package shipments. Typically, the trusted traveler and the trusted shipper have a pre-existing trust relationship through the trusted social network of the trusted traveler.

In an embodiment, the trusted traveler and the trusted shipper use the social network platform 110 to form a trusted social network for peer-to-peer package shipment delivery. The trusted social network is a social network of the trusted traveler and one or more trusted shipper such that the trusted shipper is authorized to send package shipment requests for the trusted traveler. Typically, the trust relationship between the trusted traveler and the trusted shipper is strong enough that the trusted traveler feels comfortable transporting package shipments for the trusted shipper.

It must be understood that the names trusted traveler and trusted shipper are in context of a trusted social network. For example, a trusted traveler A of a first trusted social network can be a trusted shipper A in a second trusted social network of trusted traveler B. In an embodiment, the trusted shipper pays for the package shipment delivery service of the trusted traveler. Typically, the trusted social network platform 110 provides disbursement of payment to the trusted traveler. Typically, the trusted traveler and the trusted shipper access the trusted social network platform 110 using a communication device, for example communication device 104.

In an embodiment, the trusted social network platform 110 can be integrated with the travel portals and such as Expedia.com and Priceline.com etc. In another embodiment, the trusted social network platform 110 could be integrated with the travel service providers, such as airlines and bus service providers. Typically, when the trusted traveler books his trip using a travel portal or a travel service provider, he can also send details of the trip to the trusted social network platform 110 using this integration and without any need of separately filling up the details of the trip for the trusted social network platform 110. In another embodiment, the trusted social network platform 110 is integrated with corporations, for example Google, ExxonMobil, Shell etc. and transfers portion of green credits, to the corporations when the corporation use the trusted social network platform 110 to transport package shipments.

Each of the communication devices includes a user interface. For example, the communication device 104 has a user interface 114, the communication device 106 has a user interface 116 and the communication device 108 has a user interface 118. The user interface enables the trusted traveler and the trusted shipper to interact with the trusted social network platform 110 using text, audio and/or video. Typically, a user interface, for example the user interface 114 may run on a browser such as Microsoft Internet Explorer, Google Chrome, Safari, Mosaic, Mozilla Firefox etc.

The trusted social network platform 110 includes a web server 120, a trusted social network application server 122, a database server 124 and a database 126. The web server 120 could be implemented using a commercially available Hypertext Transfer Protocol Server (HTTPS) such as Microsoft Internet Information Server (IIS), Apache web server, Sun ONE web server etc. The trusted social network application server 122 hosts the trusted social network. Typically, the trusted social network application server 122 is implemented on software framework such as Windows Server from Microsoft, Websphere application server from IBM, Sun ONE application server from Oracle etc. The database server 124 may be a commercially available server such as Microsoft SQL Server, Oracle database server, IBM DB2 database server and so forth. The database 126 is the underlying database associated with the database server 124.

The web server 120 includes a user interface generation module 128 and an application server interface module 130. Typically the web server 120 utilizes the application server interface module 130 to connect to the trusted social network application server 122. In an embodiment, the web server 120 utilizes the user interface generation module 128 to generate a user interface specific to a communication device, such as communication device 104 and send the user interface to the communication device.

The trusted social network application server 122 hosts and implements a trusted social network application 132. Typically, the trusted social network application 132 is the heart of the trusted social network platform 110 and processes and manages most of the functions that facilitate the peer-to-peer shipment delivery. In an embodiment, the data received and processed by the trusted social network platform 110 is handled by the database server 124 and eventually stored in the database 126. Typically, the database server 124 could be one or more database servers and the database 126 could be one or more databases.

In an embodiment, the trusted social network application 132 uses the social network server 112 to authenticate the identity of the trusted traveler. The trusted social network application 132 also may retrieve the trusted traveler's profile details such as name, physical address, birthdate, gender, unique identifier within the social network, email address, etc. In another embodiment, the trusted social network application 132 may retrieve contacts of the trusted traveler such as list of friends in a social network of the trusted traveler etc.

FIG. 2 is an example block diagram illustrating the trusted social network platform 110 in accordance with an embodiment of the present invention. The trusted social network platform 110 is shown to include a trip management module 202, shipping information module 204, a traveler-shipment matcher module 206, a rewards management module 208, a trust network module 210, an account management module 212, a payment management module 214, a ratings module 216, a green credit module 218, a user authentication module 220, a notification module 222 and an order management module 224.

In an embodiment, one or more modules 202 to 224 could be included in the trusted social network application 122. Typically, all the modules shown to be included in the trusted social network platform 110 may be included in the trusted social network application 122.

The trip management module 202 is configured to receive details of a trip of the trusted traveler. Typically, the trip management module 202 provides functions to edit or modify details of the trip or to delete the trip. The trip management module 202 enables the trusted traveler to modify start date, delivery date, start city, end city, weight, price per unit weight, and others parameter of the trip. Moreover, the trip management module 202 also provides functions to delete the trip or to make the trip inactive.

The trip management module 202 includes a trip submission module 226, a trip search module 228 and a trip selection module 230. The trip submission module 226 is configured to receive, validate and save details of the trip. Typically, the trip submission module 226 provides functions for submitting details of the trip. The details of the trip include start location of the trusted traveler, start date of travel, end date of travel, end location of travel, and details of the package shipment that the trusted traveler is willing to carry. In an embodiment, the details of the trip can have an approximate value, such as travel date between Dec. 12, 2014 to Dec. 15, 2014; any package shipment that can ‘fit in the trunk of my Honda CRV’; any package that can ‘fit as a carryon baggage’ in a flight etc.

The trip search module 228 is configured to search trips based on input parameters. Typically, the trusted shipper provides input parameters to search for trusted travelers. Typically, the trip search module 228 includes functions to search for trips. For example, the trip search module 228 may enable shipper to search trips using input parameter such as start city, end city, start date, delivery date, weight, and price, etc. In some embodiments of the present invention, the trip search module 228 may provide functions for searching trips based on exact match of the input parameter. For example, a shipper may input a value for start city and trip search module 204 may return all trips having start city that matches exactly with the value of the input parameter.

In another embodiment, the trip search module 228 is configured to provide search for trips based on approximate match for the input parameter. For example, the trusted shipper may input for a start city and the trip search module 228 returns not only trips having start city that exactly matches the input, but also trips having start city in a “range” of the input city. This range may be predetermined (e.g. 50 mile radius). Thus, the trip search module 228 provides trips having start city that fall within the 50 mile radius of the input city. In an embodiment, the trip search module 228 provides functions to search trips based on approximate match for other input parameters such as end city, start date, delivery date, weight, price, etc.

In an embodiment, the trip search module 228 may provide advertisements for the trusted shipper. For example, the trusted shipper when searching for trips from Dallas to San Francisco may be provided with advertisements, promotions and deals in the Dallas area. In this example, the trusted shipper could select an advertised product, for example, a handmade cowboy boots available at a local store in Dallas, and select one of more trusted shippers traveling from Dallas to San Francisco. In this example, a package shipping request is generated for the cowboy boots and is sent to the selected one or more trusted travelers. A trusted traveler then accepts the package shipment request and delivers it to the trusted shipper in San Francisco. Typically, after accepting the package shipment request, the trusted traveler can either collect the package from the local store or the local store could deliver the package shipment to an address specified by the trusted traveler.

The trip selection module 230 is configured to select a trip to place one or more package shipment requests. For example, the trip selection module 228 may enable the trusted shipper to search for a trip, select the trip, and submit a package shipment request for the selected trip. In an embodiment, the trip selection module 230 enables the trusted shipper to input shipment weight, delivery address, special notes, etc. Typically, the shipment weight may not be greater than the maximum weight specified.

The shipping information module 204 is configured to receive a package shipment requests from the trusted shipper. In an embodiment, the package shipment request includes details of the package shipment that the trusted shipper wants to be shipped. The details of the package shipment include, for example, shipment weight, delivery address, special notes, pictures of the package shipment, list of goods to be shipped, bar code to identify the package shipment etc. In an embodiment, one or more pictures of the package shipment may be taken by a mobile device, such as a camera enabled mobile phone. Typically, the invention provides an application which runs of a mobile device, such as a camera enabled mobile phone, which facilitates the trusted shipper to capture and provide details of the package shipment, such as picture of the package shipment etc. In another embodiment, the trusted social network platform 110 enables association of a unique identifier, such as Stock Keeping Unit (SKU), a bar code or a Radio Frequency Identifier (RFID) code with the package shipment. Typically, the trusted traveler and the trusted shipper may be able to provide the unique identifier using an application running on a mobile device, such as a mobile phone. The traveler-shipment matcher module 206 is configured to match the package shipment request with the trusted traveler to facilitate peer-to-peer shipment delivery. Typically the trusted social network platform 110 enables the trusted traveler to input details of the trip such as start city, end city, start date, delivery date, weight, and price, etc. Also, the trusted social network platform 110 enables the trusted shipper to input details of the package shipment such as shipment weight, delivery address, special notes, start city, destination city etc. Typically, the traveler-shipment matcher module 206 matches the package shipment requests with the trusted traveler. In an embodiment, the travel-shipment module 206 passes on the details of the package shipment provided by the trusted shipper to the trip search module 228 to search for trusted travelers that may be willing to carry the package shipment.

In another embodiment, the traveler-shipment matcher module 206 uses the details of the trip provided by the trusted traveler and matches it with one or more trusted shippers. Once a match is found the traveler-shipment matcher module 206 provides details of the one or more shipper and the corresponding package shipment details to the trusted traveler. In an embodiment, the traveler-shipment matcher module 206 provides approximate match functions to match trips with package shipments based on approximate match of the input values such as start city, end city, start date, delivery date, weight, price, etc. In another embodiment, if the traveler-shipment matcher module 206 does not find an immediate match for the trusted traveler or the trusted shipper then it will continue looking periodically for the match and when it identifies a match or an approximate match it will notify the trusted traveler and the trusted shipper.

The reward management module 208 is configured to provide rewards to the members of the trusted social media network, such as trusted travelers and trusted shippers. Typically, the rewards are based on one or more package shipments carried by the trusted traveler or may be based on the package shipment requests placed by the trusted shippers. Rewards may also be provided when a member of the trusted social media network, such as a trusted traveler referrers a non-members, such as a trusted shipper that is not a part of the trusted social media network of the trusted traveler. In an embodiment, the rewards are monetary. Typically, the monetary reward has a predetermined value that the trusted traveler would charge for carrying the package shipment. In an embodiment, the rewards are green credits or carbon credits. In another embodiment, the rewards are reward points. Typically, the trusted traveler may earn reward points when he/she decides to carry the package shipment without charging the trusted shipper. For example, the trusted traveler may earn 100 reward points for carrying the package shipment from city A to city B. In another embodiment, the reward points earned by a trusted traveler are based on the activities of the trusted traveler, for example, the trusted traveler may earn reward points when he delivers the package shipment before scheduled delivery time, for taking pictures of goods being delivered, etc. In another example, the trusted traveler may get reward points as a gift from the trusted shipper or another trusted traveler. Typically, these reward points can be redeemed for tangible goods or services. For example, a trusted traveler can redeem 20,000 reward points for an iPad, a free return flight ticket to Las Vegas or a season pass for baseball.

In an embodiment, the trusted shipper may win reward points by participating in promotions events. Typically, these promotional events could be organized by users, such as trusted travelers, trusted shippers or other user groups on the trusted social network platform 110. The other user groups include a company, a non-profit organization, community group, a school etc.

The trust network module 210 is configured to manage the trusted social network. The trusted social network interconnects the trusted traveler and the trusted shipper. Typically, the trusted social network includes the trusted traveler and one or more trusted shippers that the trusted shipper has a pre-existing trust relationship with. This pre-existing trust relationship is such that the trusted shipper is authorized to send package shipment requests with the trusted traveler. Typically, the trust relationship between the trusted traveler and the trusted shipper is strong enough and hence the trusted traveler feels comfortable transporting package shipments for the trusted shipper.

In an embodiment, the pre-existing trust relationship is based on a direct social association between the trusted traveler and the trusted shipper. This direct social association is established when the trusted traveler is directly connected with the trusted shipper through at least one social media network. The direct connection is established when there is one degree of separation between the trusted traveler and the trusted shipper in the social media network. For example, the trusted traveler and the trusted shipper who are friends with each other on a social media network, such as Facebook, have one degree of separation and thus have a direct association with each other and therefore they could form a trusted social network and rely on each other for package shipment delivery.

In another embodiment, the pre-existing trust relationship is based on an inherited social association between the trusted traveler and the trusted shipper. This inherited social association is established when the trusted traveler and the trusted shipper have an indirect connection through a social media network. The indirect connection is established when there is two or more degree of separation between the trusted traveler and the trusted shipper in the social media network. For example, a trusted traveler A is a friend of B on Facebook and B is a friend of C on Facebook. In this case A and C have two degrees of separation. Here A and C can form a trusted social network using the common connection B. In this case the trust relation between A and C is an inherited trust relationship. Both A and C inherit the trust relationship due to the common connection B on the social media network. Typically, to form a trusted social network the trusted traveler A will send a trust network formation request to C and once C accepts the trust network formation request C will become a part of the trusted social network. In an embodiment, the trusted traveler A may need an approval from B to send the trust network formation request.

The trust network module 210 includes a trust network creation module 232, a trust network management module 234, and a social network interface module 236. The trust network creation module 232 is configured to create the trusted social network. Typically, the trust network creation module 232 enables the trusted traveler to create the trusted social network, add new trusted shippers to his trusted social network. The trust network management module 234 is configured to update, delete and manage profile of the trusted traveler and the trusted shipper.

The social network interface module 236 is configured to provide interface with a plurality of social media networks and to facilitate formation of the trusted social network by utilizing one or more social media connections of at least one of the trusted traveler and the trusted shipper. Typically, the social network interface module 236 provides functions to communicate with a plurality of social media network via a network (e.g. the internet). In an embodiment, the social network interface module 236 provides functions to authenticate the trusted traveler or trusted shipper on a social network, retrieve a list of contacts of the trusted traveler or trusted shipper available on a social network, and retrieve details of the trusted traveler or trusted shipper that are stored on the social media network. Typically, details of personal profile include email address, physical address, mailing address, phone number, unique identification number, etc.

The account management module 212 is configured to manage member accounts of the trusted traveler and the trusted shipper. Typically, members of the trusted social network, for example the trusted traveler or the trusted shipper can provide details such as name, user name, contact number, mailing address etc. The account management module 212 also enables the trusted traveler and the trusted shipper to update and delete details of their accounts as well.

The payment management module 214 is configured to process payments. In an embodiment, the payment management module 214 enables the trusted shipper to input payment data, for example credit card information, validate the payment data, submit the payment data to a processing server, for example, a payment gateway and provides payment processing results. The payment management module 214 also provides functions to disburse payments to the trusted traveler and the trusted shipper. Typically, the payment management module 214 allocates payments to the trusted traveler at specific intervals. In one embodiment, the payment management module 214 may enable the trusted traveler to verify identity of trusted shippers and perform payment transactions securely. In another embodiment, the payment management module facilitates in providing insurance for the package shipment. Typically, the payment management module provides an interface with an insurance provider. The insurance provider can be used by the trusted traveler or the trusted shipper to insure the package shipment. In case of non-delivery or damage of the package shipment the trusted shipper is compensated by the insurance provider. In an embodiment the trusted social network platform insures the package shipment.

The ratings module 216 is configured to manage ratings of the trusted traveler and the trusted shipper. The trusted traveler is rated on the package shipment delivered and the trusted shipper is rated on the package shipment requested. In an embodiment, the trusted traveler is rated by the trusted shipper wherein the trusted shipper has used package shipment delivery services of the trusted traveler. Typically, the trusted shipper is also rated by the trusted traveler when the trusted traveler has delivered package shipments for the trusted shipper. These ratings can be used as a factor by the trusted shipper to select the trusted traveler for delivering package shipments and also by the trusted traveler to select or reject a package shipment request.

The green credit module 218 is configured to determine green credits earned by the package shipment delivery. The green credits are based on the reduction in the energy usage achieved by the package shipment delivery facilitated by the trusted social network platform 110, when compared to energy usage if the package shipment were delivered by traditional shipment delivery service providers, such as FedEx, USPS and UPS etc. In an embodiment, green credits are carbon credits. Typically, the green credits earned by the trusted travelers and the trusted shipper on package shipment delivery will be transferred to them. In an embodiment, companies such as corporate organization, schools, non-profits, and even transport service providers can sign up as a trusted shipper with the trusted social network 110 to transport package shipment goods. Typically, the green credits earned by the package shipment delivery will be transferred to these companies.

The user authentication module 220 is configured to provide authentication of the trusted traveler and the trusted shipper. Typically, the authentication may utilize authentication schemes such as username and password based authentication, cookie based authentication, public key infrastructure (PKI) authentication etc.

The notifications module 222 is configured to manage generation and delivery of notifications. Typically, a notification is delivered via email, text message, multimedia message, paging message, automated call etc. In an embodiment, when the trusted shipper places a package shipment request the notifications module 222 generates an email and sends the email to one or more trusted travelers. Typically, the one or more trusted travelers are the ones who have the trusted shipper in their trusted social network. When the trusted traveler accepts the package shipment request the notifications module 222 generates an acceptance email and sends it to the trusted shipper.

The order management module 224 is configured to provide functions to view package shipment requests, and save package shipment requests to the database 126. In an embodiment, the order management module 224 enables the trusted traveler and the trusted shipper to view details of package shipment requests such as request date, request status etc.

FIG. 3 is a flow diagram illustrating a method 300 for facilitating peer-to-peer shipment delivery in a trusted social network, in accordance with an embodiment. To describe the method 300, reference has been made to FIG. 1 and FIG. 2, although it should be understood that the method 300 can be implemented in any other suitable environment or network. Moreover, the invention is not limited to the order in which the steps are listed in the method 300.

Initially, the trusted traveler sends a trust network formation request to the trusted shipper which the trusted shipper accepts. After acceptance the trusted traveler and the trusted shipper become a part of the trusted social network of the trusted traveler. At step 302, the method for facilitating peer-to-peer shipment delivery in a trusted social network is initiated. Typically, the method is performed at the trusted social network platform 110.

At step 304, the trusted social network platform 110 receives details of a trip of the trusted traveler. In an embodiment, the trusted traveler sends the details of the trip to the social network platform 110. Typically, details of the trip includes but is not limited to start location of the trusted traveler, start date of travel, end date of travel, end location of travel, details of capacity, and details of the package shipment that the trusted traveler is willing to carry. In an embodiment, the details of the trip could include a trip schedule as well. For example, a trusted traveler who commutes every weekend from San Francisco to Los Angeles could include his trip schedule for the next three months in the details of the trip. In an embodiment, the details of the trip are delivered to all the trusted shippers in the trusted social network of the trusted traveler. In another embodiment, the details of the trip are sent to some of the trusted shippers in the trusted social network of the trusted traveler based on a predefined criteria. Typically, the trusted traveler sets these predefined criteria. In yet another embodiment, the details of the trip are sent to all the users of the trusted social media network. Typically, the trusted traveler may decide the details of the trip to share with the trusted shippers that are part of this trusted social network and the details of the trip to share with other users that are not part of his trusted social network. In an embodiment, the details of the trip are validated by the trusted social network platform 110 before saving them in the database 126.

At step 306, the trusted social network platform receives a package shipment request of the trusted shipper. In an embodiment, the package shipment request includes search parameters used by the trusted shippers when searching for a trip. Typically, the package shipment request is created and sent to the trusted social network platform 110. For example, a trusted shipper may search for a trip from San Francisco to Dallas to send a package shipment of 2 lbs. on Jan. 10, 2014. In this case once the trusted shipper provides these search parameters a package shipment request is created and sent to the trusted social network platform 110.

At step 308, the package shipment request is matched with the trusted traveler to facilitate the peer-to-peer shipment delivery. The matching includes identifying one or more trusted travelers that could potentially carry the package shipment for the trusted shipper. For example, if the trusted shipper wants a package shipment of 2 lbs. to be transported from San Francisco to New York on Jan. 5, 2015 and there is a trusted traveler traveling from San Francisco to New York on Jan. 4, 2015 and willing to carry up to 20 lbs. then the shipment request is matched with the trusted traveler.

Typically, the trusted social network platform 110 matches the package shipment request with the trip of the trusted traveler to facilitate peer-to-peer shipment delivery. In an embodiment, after matching the trusted social network platform 110 send a list of matched trips of one or more trusted travelers. In this embodiment, the trusted shipper may select a trip of the trusted traveler from the list. Typically, the trusted shipper may set a selection criteria to automatically select a trip. For example, the listing may include 15 trips from San Francisco to Dallas on Jan. 10, 2015 and a particular trusted traveler is automatically selected because the trusted traveler has carried a package shipment for the trusted shipper before.

After selecting the trip of the trusted traveler, the trusted shipper may place a package shipment request. Once the package shipment request is placed the trusted traveler receives a notification. In an embodiment, the trusted traveler may accept or reject the package shipment request. Typically, the trusted traveler views the order and then accepts or rejects the same. Irrespective of the acceptance/rejection the trusted shipper receives a notification about the trusted traveler's action of acceptance or rejection. In case the trusted traveler accepts the order the trusted shipper may provide details for payment. Typically, the details include credit card details of the trusted shipper. In an embodiment, after selecting the trip of the trusted traveler, the trusted shipper may send messages to the trusted shipper through the trusted social network platform 110 and negotiate about the package shipment delivery. Typically, the trusted shipper and the trusted traveler may discuss details of the trip, for example, travel dates, compensation, weight etc. by exchanging private messages and once they agree on the details of the trip the trusted shipper may send a package shipment request for the trusted traveler. In this embodiment the trusted traveler promptly accepts the package shipments request as the details of the trip are already discussed with the trusted shipper.

Thereafter, the trusted shipper may deliver the package shipment at the address specified by the trusted traveler so that the trusted traveler can pick up the package shipment. Thereafter the trusted traveler picks up the package shipment and carries it to the location specified by the trusted shipper. In an embodiment, the trusted shipper is able to track the status of the package shipment while in transit. In an embodiment, the trusted shipper is able to track the status of the package shipment while in transit. Typically, this tacking is facilitated by Global Positioning System (GPS) system carried by the trusted traveler. In an embodiment, the GPS system is a mobile device, such as a GPS enabled mobile phone which can be used to track the location of the trusted traveler and the package shipment.

Typically, the trusted traveler drops the package shipment to a pre specified location. In an embodiment the pre specified location includes but is not limited to include, but are not limited to, dedicated shops, coffee shops, bookstores, malls, automated kiosks, post offices, restaurant, drivethroughs, bank drivethroughs, cubbyholes in convenient public transit stations, and so forth. Typically, the trusted social network platform stores the pre specified locations preferences of the trusted traveler and the trusted shipper. Such preferences can be used by the trusted social network to create a profile of the trusted traveler and the trusted shipper and offer them customized services. In an embodiment, the trusted shipper may arrange someone to pick up the package shipment from the trusted traveler once the trusted traveler has reached his destination. Once the package shipment is received the trusted shipper gets a notification confirming delivery of the package shipment.

In another embodiment, the trusted shipper may use the package shipment services offered by multiple trusted shippers to transport his package. For example, a trusted shipper P who wants to send a package shipment from San Francisco to New York can select a trusted shipper Q to deliver the package shipment to Chicago and a trusted traveler R to deliver the package shipment from Chicago to New York.

At step 310, once the package shipment is delivered, the trusted social network platform 110 may provide reward to the trusted traveler. Typically, the reward is based on one or more package shipments carried by the trusted traveler. In an embodiment, the reward is a monetary reward. In another embodiment the rewards are green credits. Typically, the trusted social network platform 110 processes payments for the trusted traveler and the trusted shipper. On delivery of the package shipment, the payment for the package shipment delivery is released for the trusted traveler. After delivery of the package shipment, the trusted traveler sends a payment approval notification to the trusted social network platform 110 to release payments for the trusted traveler. Once the package shipment is delivered the trusted shipper provides rating to the trusted traveler and the trusted traveler provided ratings to the trusted shipper. Thereafter, the method 300 terminates at step 312.

FIG. 4 is a block diagram of environment 400 depicting trusted social network in accordance with an embodiment of the present invention. The environment 400 is shown to include a communication network 402. The communication network 402 may be geographically spread over an area, such as a building, a campus, a city, and so forth. Examples of the communication network 402 include a Local Area Network (LAN), a Metropolitan Area Network (MAN), a Wide Area Network (WAN) such as the Internet, and so forth. In any case, the communication network 402 can be a client-server network or a peer-to-peer network.

The communication network 402 facilitates formation of a plurality of trusted social networks by facilitating interconnection between trusted travelers and trusted shippers. The communication network 402 is shown to include a trusted social network 404, and a trusted social network 406. Each trusted social network includes a trusted traveler and one or more trusted shippers. For example, the trusted social network 404 includes a trusted traveler 408, a trusted shipper 410 and a trusted shipper 412. Similarly, the trusted network 406 includes the trusted shipper 412, a trusted traveler 414, and trusted shipper 416. Here, the trusted shipper 412 is a part of both the trusted social network 404 and the trusted social network 406.

In an embodiment, the trusted social network platform 110 enables the trusted traveler, for example the trusted traveler 408 to form a trusted social network, for example trusted social network 404 that includes one more trusted shippers. The trusted traveler and the trusted shipper have a pre-existing trust relationship through the trusted social network such that the trusted shipper is authorized to send package shipment requests for the trusted traveler. Typically the trusted traveler is the administrator of his trusted social network and can add or remove trusted shippers from his trusted social network. Typically, the trusted shipper could be a part of one or more trusted social networks. For example, the trusted shipper 412 is a part of the trusted social network 404 and the trusted social network 406.

It must also be understood that the term trusted traveler and trusted shipper is in context of a trusted social network. For example, a trusted traveler A of a first trusted social network could become a trusted shipper A in a second trusted social network of trusted traveler B.

FIG. 5 is a block diagram that illustrates a mathematical formula for determining a Trust Score (TS) in accordance with an embodiment of the present invention. In an embodiment, the trusted social network platform 110 enables a trusted traveler to set up a trusted social network based on a Trust Score (TS). The Trust Score (TS) is assigned to the trusted shippers and measures the level of trust relationship between the trusted traveler and the trusted shipper. Typically, the Trust Score (TS) has a value that is assigned to a trusted shipper. In an embodiment, the pre-existing trust relationship between the trusted traveler and the trusted shipper is established when the Trust Score (TS) of the trusted shipper is more than a predetermined value.

In an embodiment, the Trust Score (TS) is based on at least one of the six scores. The six scores include an organizational score (OS), a social score (SS), an affinity score (AS), a rating score (RS), a transaction score (TXS), and a profile score (PS). Typically, the trusted social network platform 110 assigns a scale value to measure each of these six scores. For example the organizational score (OS) could take up a scale value of 0 to 10 and a social score (SS) could take up a scale value of 0 to 5. Accordingly, the scale values of one or more of the six scores could be same or different. In an embodiment, the trusted traveler assigns scale values to one or more of the six scores. Typically, the trusted traveler could set criteria to determine the value of the six scores.

The organizational score (OS) is based on organizational association between the trusted traveler and the trusted shipper. Examples of an organization include a corporate organization, an academic institution, a charity group and so forth. Typically and organization employs plurality of individuals. When two individuals are associated with same organization there is a higher probability that trust among them will be higher compared to if they were complete strangers. Accordingly, if the trusted traveler and the trusted shipper are associated with the same organization then the organization score (OS) will be higher compared to if they were not a part of the same organization.

The social score (SS) is based on social association between the trusted traveler and the trusted shipper. Typically the social association is at least one of a direct social association and an inherited social association. The direct social association is established when the trusted traveler has a direct connection with the trusted shipper through at least one social media network, such as Facebook, Google+, and LinkedIn etc. When the trusted traveler and the trusted shipper are directly connected over the social media network they have one degree of separation between them.

Inherited social association is established when the trusted traveler and the trusted shipper have an indirect connection through the social media network. The indirect connection is established when there is two or more degree of separation between the trusted traveler and the trusted shipper in the social media network. For example, if the trusted traveler and the trusted shipper are connected though a common connection on a social media network, such as Facebook they have two degree of separation between them.

Accordingly, a trusted traveler and a trusted shipper who have a lower degree of separation on a social media network will have a higher social association and a higher social score (SS). Accordingly, if the trusted traveler and the trusted shipper have a low degree of separation on the social media network, then their social score (SS) will be high and vice versa.

The affinity score (AS) is based on personal affinity between the trusted traveler and the trusted shipper. Typically, in a social media network, such as Facebook, a user may have different level of affinity with other users. For example, on a social media network such as Facebook, a user may have a higher affinity with a family member or a best friend compared to a friend who is just an acquaintance. When two individuals have higher affinity there is a higher probability that trust among them will be higher compared to if have lower affinity. Accordingly, a trusted traveler may have a high affinity score (AS) for a trusted shipper when he has a high affinity with the trusted shipper and vice versa.

Rating score (RS) is based on rating received by the trusted traveler and the trusted shipper. Typically, the rating is an indication of the quality service for the package shipments delivered. A higher rating will result in a higher rating score (RS) and vice versa.

The transaction score (TXS) is based on one of the package shipments requests associated with the trusted traveler and the trusted shipper. Typically, the requests associated with the trusted traveler and the trusted shipper is based on number of package shipment carried by the trusted traveler and the number or package shipments requests raised by the trusted shipper. Typically, the higher the number of package carried or ordered the higher will be the transaction score (TXS). In an embodiment, the trusted social network platform 110 may consider a subset of the package shipment carried or ordered based on predefined criteria for the purpose of determining the transaction score (TXS). Typically, one of the trusted traveler or the trusted shipper sets the predefined criteria.

The profile score (PS) is based on the personal profile of the trusted traveler or the trusted shipper. The personal profile includes factors such as gender, age, city of residence, recommendations etc.

In an embodiment, the Trust Score (TS) is based on the weighted average of at least two of the organizational score (OS), the social score (SS), the affinity score (AS), the rating score (RS), the transaction score (TXS), and the profile score (PS). Typically, the weighted average is calculated based on at least two of six weightages. The six weightages are weightage of organizational score (WOS), weightage of social score (WSS), weightage of affinity score (WAS), weightage of rating score (WRS), weightage of transaction score (WTXS), and weightage of profile score (WPS).

In an embodiment, the trusted social network platform 110 may provide value to each of the six weightages. Typically, the trusted shipper or the trusted traveler may set the weightage values of one or more of the six weightages. In an embodiment, the weightage values could take any value on a scale of 0 to 10. In one embodiment, the Trust Score (TS) is calculated as:

$$Trust Score ( TS ) = \frac{( \begin{matrix}OS * WOS + SS * WSS + AS * WAS + RS * WRS + \\ TXS * WTXS + PS * WPS\end{matrix} )}{( WOS + WSS + WAS + WRS + WTXS + WPS )}$$

FIG. 6 is a flow diagram illustrating a method 600 depicting formation of a trusted social network based on Trust Score (TS) in accordance with an embodiment of the present invention. To describe the method 600, reference has been made to FIG. 1 and FIG. 4 and FIG. 5, although it should be understood that the method 600 can be implemented in any other suitable environment or network. Moreover, the invention is not limited to the order in which the steps are listed in the method 600.

Typically, a trusted traveler, for example the trusted traveler 406 sends a trust network formation request to one or more trusted shippers, for example, the trusted shipper 408, trusted shipper 410, and trusted shipper 412. Once the trusted shipper accepts the trust network formation request the trusted shipper becomes a part of the trusted social network of the trusted traveler. For example, the trust network formation request sent by the trusted traveler 406 was accepted by the trusted shipper 408 and 410 but not by trusted shipper 412. Accordingly, the trust network 402 of the trusted traveler 406 is formed which includes the trusted traveler 402 and the trusted shipper 408 and 410.

Prior to sending the trust network formation request, the trusted traveler determines which trusted shippers it should send the trust network formation request. Typically, this determination is made on the basis of the Trust Score (TS).

At step 602, the method depicting formation of a trusted social network based on Trust Score (TS) is initiated. At step 604 the Trust score (TS) is calculated for a trusted shipper. For example, when the trusted traveler 406 initiates he formation of trusted network it calculates the Trust Score (TS) of the one or more trusted shippers, for example the trusted shipper 408, 410, 412, and 414. Typically the trust score (TS) is based on the weighted average of the organizational score (OS), the social score (SS), the affinity score (AS), the rating score (RS), the transaction score (TXS), and the profile score (PS). Typically, the Trust Score (TS) is determined based on the embodiments disclosed in the description of FIG. 5. Once the Trust Score (TS) is determined the trusted traveler send the trust network initiation request based on the value of the Trust Score (TS).

At step 606, the trusted traveler 406 determines whether value of Trust Score (TS) of a trusted shipper is more than or equal to a threshold value. Typically, the threshold value is predetermined by the trusted traveler. For example, the trusted traveler 406 may determine that the Trust Score (TS) value of the trusted shipper 408, 410, 412, and 414 are 9, 8, 7, and 3 respectively and the threshold value is 5.

At step 608, a trust network formation request is sent by the trusted traveler to a trusted shipper when value of the Trust Score (TS) of the trusted shipper is more than the threshold value. For example, the trusted traveler 406 may send the trust network formation request to the trusted shipper 408, 410, and 412 and not to the trusted traveler 414. Once the trust network formation request is accepted by the trusted shipper the trusted shipper is added to the trusted social network of the trusted traveler. For example, the trusted shipper 408 and 410 accept and become a part of the trusted social network of the trusted traveler 406 and the trusted traveler 412 does not accept and thus does not become a part of the trusted social network of the trusted traveler 406. Thereafter, the method terminates at step 612.

At step 606, the trusted traveler, for example the trusted traveler 406 determines that the value of Trust Score (TS) of a trusted shipper is less than the threshold value. Then, at step 610 the trusted traveler does not send the trust network formation request. Thereafter, the method terminates at step 612.

FIG. 7 is a block diagram illustrating an environment 700, in accordance with a second embodiment of invention. The environment 700 includes a communication network 702. The communication network 702 may be geographically spread over an area, such as a building, a campus, a city, and so forth. Examples of the communication network 702 include a Local Area Network (LAN), a Metropolitan Area Network (MAN), a Wide Area Network (WAN) such as the Internet, and so forth. In any case, the communication network 702 can be a client-server network or a peer-to-peer network.

Regardless of the type, the communication network 702 includes a plurality of clients. For example, the communication network 702 is shown to include a client 704, client 706, and client 708. Each of the clients includes a user interface. For example, the client 704 includes a user interface 710, client 706 includes a user interface 712, and client 708 includes a user interface 714. In addition the communication network 702 is also associated with a shipping platform 716 and a social media network server 718. In an embodiment, the shipping platform 716 is a trusted social network platform for the trusted traveler and the trusted shipper and the social media network server 718 is a server hosting a social network application such as Facebook, Twitter, and Google+ etc. Typically, the trusted traveler or the trusted shipper use the user interface, for example user interface 710 to access a shipping platform 716.

The shipping platform 716 includes a Web Server 720, an application server 722, a database server 726 and a database 730. Typically, the Web Server 720 is a commercially available HTTP server such as Microsoft Internet Information Server (IIS), Apache web server, Sun ONE web server etc. The application server 722 typically has installed software frameworks such as Windows Server from Microsoft, Websphere application server from IBM, Sun ONE application server from Oracle, etc. The database server 726 may be a commercially available server such as Microsoft SQL Server, Oracle database server, IBM DB2 database server etc. The database 730 is the underlying database associated with the database server 726.

The Web Server 720 includes a user interface generation module 734 and an application server interface module 732. Typically, the Web Server utilizes the application server interface module 732 to connect to the application server 722. In an embodiment, the Web Server 720 utilizes the user interface generation module 734 to generate a user interface screen and return the user interface screen to a client, for example the client 100a via the communication network 702.

The invention provides a shipping platform 716, such as the trusted social network platform and a method to facilitate shipping of goods, such as package shipments by connecting trusted travelers and trusted shippers over the communication network 702. The trusted traveler offers shipping services to transport package shipments and the trusted shipper seeks shipping services to send package shipments. Typically, the trusted shipper compensates the trusted traveler for the shipping services. The system and method facilitates disbursement of payment to the trusted traveler upon successful delivery of the package shipment.

Typically, the trusted traveler utilizes the user interface, for example the user interface 710 of the client 704 to submit details of a trip to the Web Server 720 via the communication network 702. The Web Server 720 may utilize an application server interface module 732 to connect to an application server 722. The Web Server 720 may forward details of the trip to the application server 722. The application server 722 may include a shipping application 724, such as a trusted social network application that processes detail of the trip and submits the details to the database server 726. Eventually the details of the trip are stored in the database 730.

In an embodiment, the trusted shipper utilizes the user interface, for example the user interface 710 to submit a request for searching a trip. This request is received at the Web Server 720 via the communication network 702. The Web Server 720 may process the request by connecting to an application server 722 via an application server interface module 732. The shipping application 724 may process the request by retrieving details of one or more trips from the database 730. The application server 722 may return the details of the one or more trips to the Web Server 720 via the application server interface module 732. The Web Server 720 may utilize the user interface generation module 734 to generate a user interface screen and send the user interface details to the client 704. The client 704 may then display the details on the user interface 710.

In an embodiment, a trusted traveler may create a trusted social network of trusted shippers. The trusted social network of the trusted traveler may include the trusted traveler and one or more trusted shippers that the trusted traveler has trust relationship with. The trust relationship is so strong that the trusted traveler feels comfortable transporting package shipments for one or more trusted shippers of his trusted social network.

In an embodiment, the trusted traveler may create a trusted social network while submitting a trip. The trusted traveler may use email address or use his connections of a social media network (e.g. Facebook, Twitter) to add a trusted shipper to his trusted social network. To utilize the social media network, a request is generated from a user interface, for example the user interface 110a and is sent to the Web Server 720 via the communication network 702. The Web Server 720 may forward the request to application server 722 via the application server interface module 732. The application server 722 may utilize the shipping application 724 to connect to the social media network server 718. Thereafter, the shipping application 724 may authenticate the identity of the trusted traveler on the social media network server 718 via the user authentication component 736. The shipping application 724 may retrieve profile details of the trusted traveler (e.g. name, address, birthdate, gender, unique identifier within the social network, email address, etc.) from the social media network server 718 via the user profile component 738. The shipping application 724 may further retrieve contacts of the trusted traveler for example, list of friends via the user's contacts component 740.

FIG. 8 is an example block diagram illustrating components of the shipping application 724 in accordance with an embodiment. The shipping application 724 includes a trip submission module 802, a trip search module 804, a trip selection module 806, a trip management module 808, an order management module 810, a payment processing module 812, a notifications module 814, a user ratings module 816, a payment disbursement module 818, a social network server interface module 820, a trust network creation module 822, a trust network management module 824, and a user authentication module 826.

The trip submission module 802 provides functions for submitting a trip. For example, the trip submission module 802 may enable a trusted traveler to input details of the trip, validate details of the trip, and save details of the trip into the database 730. The trip search module 804 provides functions for searching trips. For example, the trip search module 804 may enable the trusted shipper to search trips using search criteria such as start city, end city, start date, delivery date, weight, price, etc.

In an embodiment, the trip search module 804 may provide functions for searching trips based on exact match of the input criteria. For example, the trusted shipper may input a value for start city and trip search module 804 may return all trips having start city that matches exactly with the input value.

In another embodiment, the trip search module 804 provides functions for searching trips based on approximate match of the input criteria. For example, a trusted shipper may input a value for start city and the trip search module 804 may return not only trips having start city that exactly matches the input value, but also trips having start city in a “range” of the input city value. The range may be a predetermined value (e.g. 50 mile radius). Thus, the trip search module 804 may return trips having start city that fall within the 50 mile radius of the input city. The trip search module 804 may also provide functions to search trips based on approximate match for other input values such as end city, start date, delivery date, weight, price, etc.

The trip selection module 806 provides functions to select a trip and place a package shipment request for the selected trip. For example, the trip selection module 806 may enable the trusted shipper to search for a specific trip, select the trip, make necessary changes to the selected trip, and then submit a package shipment request for the selected trip. The trip selection module 806 may enable the trusted shipper to input shipment weight, delivery address, special notes, etc. Typically, the input value for the weight may not be greater than the maximum weight specified.

The trip management module 808 may provide functions to edit details of the trip and to delete the trip. For example, the trip management module 808 may enable the trusted traveler to modify start date, delivery date, start city, end city, weight, price per unit weight etc. Typically, the trip management module 808 also provides functions to delete the trip or make the trip inactive. The order management module 810 provides functions to view package shipment requests, and save package shipment requests. Typically, the order management module 810 may enable the trusted traveler to view details of the package shipment request such as request date, request status etc.

The payment processing module 812 provides functions to accept payment data and process payments. For example, the payment processing module 812 enables trusted shippers to input payment data (e.g. credit card details), validate the input payment data, and submit the payment data to a processing server (e.g. a payment gateway such as Authorize.net that accepts payments via internet) and return payment processing results.

The notifications module 814 provides functions to generate notifications and sends them to the trusted traveler. For example, upon creation of a new package shipment request the notifications module 814 may generate an email and send the email to the trusted traveler and to a system administrator of the trusted social network. Further, on acceptance of the package shipment request by the trusted traveler, the notifications module 814 may generate an email and send it to the trusted shipper.

The user ratings module 816 may enable the trusted traveler and the trusted shipper to rate each other for the package shipment delivery. For example, the user ratings module 816 may enable the trusted shippers to rate the trusted traveler for the package shipment delivery service rendered by the trusted traveler. The payment disbursement module 818 provides functions to disburse payments to the trusted travelers. Typically, the payment disbursement module 818 disburses payments to trusted travelers at specific intervals.

The social network server interface module 820 provides functions to communicate with the social network server 718 via the communication network 702. For example, the social network server interface module 820 may provide functions to authenticate the trusted traveler on the social media network server 718, provide functions to retrieve a list of contacts of the trusted traveler from the social media network server 718, and provide functions to retrieve the profile details of the trusted traveler that are stored on the social media network server 718. A profile of the trusted traveler may include the email address, residence address, mailing address, phone number, unique identification number, etc.

The trust network creation module 822 provides functions to create the trusted social network and manage the trusted social network. For example, the trust network creation module 822 may enable the trusted traveler to create a trusted social network including one or more trusted shippers, add new trusted shippers to his trusted social network. The trust network management module 824 allows trusted traveler to remove trusted shippers from his trusted social network.

The user authentication module 826 provides functions to authenticate the trusted traveler and the trusted shipper. These functions to authenticate may utilize various authentication schemes such as username and password based authentication, cookie based authentication, public key infrastructure (PKI) authentication and other authentication techniques.

FIG. 9 is an exemplary block diagram illustrating a sign-up interface 900 in accordance with an embodiment. The sign-up interface 900 enables the trusted traveler and the trusted shipper to become a member of the trusted social network. Typically, the trusted traveler and the trusted shipper can input a username using a username input box 902, an email address using an email input box 904 and a password using a password input box 906.

FIG. 10 is an exemplary block diagram illustrating a user interface 1000 depicting submission of detail of a trip, in accordance with an embodiment. Typically, the user interface 1000 is accessible via a secured internet connection and enables the trusted traveler to provide details of the trip. For example, a trusted traveler traveling from Sunnyvale, Calif. to Chicago, Ill. may input name or the city, for example Sunnyvale, Calif. where his travel begins into a From city input box 1002, the city where the travel ends, for example Chicago, Ill. into the To city input box 1004, start date of the travel, for example Dec. 4, 2012 into start date input box 1006, expected date of delivery, for example Dec. 5, 2012 into Delivery date input box 1008, date by which traveler may desire shipment be in his possession, for example Dec. 2, 2012 into Latest date to receive package input box 1010, maximum weight of shipment the trusted traveler desires to transport, for example 25 lbs. into Total weight input box 1012, and price per pound traveler desires to charge, for example $4.35 into Price per lbs. input box 1014.

The user interface 1000 may also enable the trusted traveler to post a message on a social media network about his upcoming trip. The user interface 1000 may also enable the trusted traveler to notify the trusted shipper about his trip through an email or social media network, such as Facebook, and Twitter, etc. The trusted traveler may notify the trusted shipper by providing email address of the trusted shipper or by selecting the trusted shipper from his social media network connections and sending a notification using the Notify a Friend selection box 1016. Typically, the trusted traveler may post a message on his Facebook wall, post a tweet into his Twitter stream by selecting option on a Social Network Checkbox 1018

FIG. 11 is a block diagram depicting user interface 1100 depicting selection of notification during submission of the detail of the trip, in accordance with an embodiment. Typically, the user interface 1100 enables the trusted traveler to select trusted shippers using email addresses or social media network connections such as, Facebook, and Twitter, etc.

In an embodiment, the use interface 1100 is presented to the trusted traveler when the trusted traveler selects Notify a Friend selection box 1016. The trusted traveler may select to notify trusted shippers of this trusted social network through an email, a Facebook message, a Twitter Tweet, or other means by selecting appropriate options on the Notify friends section 1102. The trusted traveler may also provide email addresses of one or more trusted travelers by inputting the email addresses in Enter email address section 1104. For example, the trusted traveler may input email addresses of three trusted shippers, Shipper1@ gmail.com, Shipper2@ yahoo.com, and Shipper3@hotmail.com respectively using input boxes provided by the Enter email address section 1104. The user interface 1100 also enables the trusted traveler to select trusted shippers using social media network such as Facebook and Twitter.

Typically, the trusted traveler may use the Select Friends from Facebook section 1106 to select trusted shippers from his Facebook connections and Select Friends from Twitter section 1108 to select trusted shippers from his Twitter network. For example, the trusted traveler may select three friends, Shipper10, Shipper12 and Shipper13 by selecting the appropriate checkboxes from the Select Friends from Facebook section 1106. Similarly, the trusted traveler may select three trusted shippers, Shipper20, Shipper21 and Shipper22 from his Twitter network by selecting appropriate checkboxes on the Select Friends from Twitter section 1108.

FIG. 12 is a block diagram illustrating notification summary interface 1200, in accordance with an embodiment. Typically, the notification summary interface 1200 enables the trusted traveler to confirm selected trusted shippers. Typically, the notifications summary interface 1200 enables the trusted traveler to review the trusted shippers that he has selected using email, Facebook, Twitter, etc. If the trusted traveler desires to make changes, he may do so by selecting the edit button 1202 to edit the selected trusted shippers using email address, the edit button 1204 to edit trusted shippers selected from Facebook, and the edit button 1206 to edit trusted shippers selected from Twitter.

FIG. 13 is a block diagram illustrating search interface 1300 in accordance with an embodiment. Typically, the search interface 1300 enables the trusted shipper to provide one or more values for search parameters and retrieve results. The search interface 1300 enables the trusted shipper to find trips having a specific origin city, destination city, start date, end date, weight, price, etc. Typically, the trusted shipper can input the one or more values in any of a From City box 1302, a To City box 1304, a Start Date box 1306, a Delivery Date box 1308, a Weight box 1310, and a Price box 1312. Once the user has provided the one or more values he may select the Search button 1314 to view search results. For example, the search interface 1300 may enable the trusted shipper to find trips that originate in Sunnyvale, Calif. The trusted shipper may input this into the From City box 1302 select Search button 1314. This will result in retrieving all trips originating from Sunnyvale, Calif. In an embodiment, the search interface 1300 may return approximate match for an input parameter such as start city, end city, start date, delivery date, weight, price, etc.

FIG. 14 is a block diagram illustrating user interface 1400 for a package shipment request, in accordance with an embodiment. The user interface 1400 may display one or more results. Typically, for each trip displayed as one or more results, the user interface 1400 displays start date, delivery date, start city, end city, unique id of the trusted traveler in the trusted social network platform 110, maximum weight that a trusted traveler is willing to carry, price etc.

In an embodiment, the user interface 1400 may display a subset of trips (e.g. 8 trips) and may enable a user, such as the trusted shipper to view different subsets of trips using previous 10 trips button 1402 and next 10 trips button 1404. The user interface 1400 may also display an informational message 1406, for example “showing 1 to 8 of 20. The user interface 1400 may enable the trusted shipper to filter the displayed results by inputting trip related data into filter box 1408. Typically, the trusted shipper can input trip related data such as start date, location, price, weight, delivery date, start city, end city, weight, price, unique id of the trusted traveler etc. The user interface 1400 may further enable the trusted shipper to select a specific trip from the displayed list.

FIG. 15 is a block diagram illustrating user interface 1500 for reviewing a selected trip, in accordance with an embodiment. The user interface 1500 may enable the trusted shipper to view details of a selected trip. The details include start city, end city, start date, delivery date, price, weight shown in the weight box 1502, sub-total price shown in the sub-total price box 1504, and total price shown in the total price box 1506. The user interface 1500 may also enable the trusted shipper to edit of the weight. For example, the package shipment that the trusted shipper wants to be shipped may only weigh 20 pounds, while the selected trusted traveler trip may accommodate up to 35 pounds. In this case, the trusted shipper may input 20 pounds into the weight box 1502. Typically, the user interface 1500 may enable the trusted shipper to modify the weight value up to the maximum weight allowed for the trip. In an embodiment, the user interface 1500 may calculate the sub-total price and total price based on the value of the weight entered by the trusted shipper in the weight box 1502.

FIG. 16 is a block diagram illustrating a user interface 1600 for placing a package shipment request, in accordance with an embodiment. The user interface 1600 may enable a trusted shipper to verify the details of a selected trip. The user interface 1600 screen may further enable a user to modify the value for weight by selecting the edit button 1602. The user interface screen may enable a user, for example the trusted shipper to place a package shipment request by selecting a place order button 1604.

FIG. 17 is a block diagram illustrating a user interface 1700 for accepting a package shipment request, in accordance with an embodiment. The user interface 1700 may present one or more package shipment requests. For each package shipment request the user interface 1700 may provide request date, unique id of the trusted shipper, name of the trusted shipper, weight, total price, etc. Typically, the user interface 1700 enables the trusted traveler to select a specific package shipment request.

FIG. 18 is block diagram of a user interface 1800 for accepting the package shipment request, in accordance with a second embodiment. The user interface 1800 enables the trusted traveler to approve or reject a package shipment request by using an Approve/Reject button 1802 and Approve request section 1804 and Reject order section 1806. For example, the trusted traveler may approve the package shipment request and also desire to pick up the package shipment from address specified by the trusted shipper. The trusted traveler may approve a package shipment request and also provide an address in Address box 1806 to receive the package shipment. Typically, the address could be an address of the trusted shipper which the trusted shipper could use to receive the package shipment via traditional shipping service providers, for example UPS, FedEx, USPS etc. The trusted traveler may reject a package shipment request and may provide a reason for rejection using the Reject Request section 1808.

FIG. 19 is a block diagram illustrating a user interface 1900 for providing payment details, in accordance with an embodiment. Typically, a trusted shipper may input credit card information 1902, billing address 1904, address at which the package shipment is to be delivered 1906 etc.

FIG. 20 is a block diagram illustrating a user interface 2000 to review payment information in accordance with an embodiment. Typically, the user interface 2000 displays a payment summary and enables the trusted shipper to view and edit credit card information and other information such as delivery address of the package shipment. The user interface 2000 also enables the trusted shipper to review and confirm the credit card information and delivery address information. Typically, the user interface 2000 enables the trusted shipper to make changes to credit card information, billing address, delivery address, or other information by selecting an edit button. The user interface screen may also display the cost for package shipment deliver in order total box 2002.

FIG. 21 is a block diagram illustrating a computer system 2100 where various embodiments of the present invention can be practiced. The computer system 2100 includes a system bus 2102, a processing unit 2104, a Memory 2106, a network interface controller 2108, a display adapter and display device 2110, an input/output controllers 2112, and an input/output device 2114.

Embodiments of the present invention provide various steps and operations, which in turn may be translated into machine readable and machine executable instructions. These instructions along with related data may be stored in the Memory 2106. Instructions and data may be placed into the Memory 2106 from the input/output devices 2114 (such as a keyboard, mouse) or a secondary storage device. The processing unit 2104 may interact with Memory 2106 to access both stored instructions and data. The processing unit 2104 may execute these stored instructions. The network interface controller 2108 may connect the computer system 2100 to a network (e.g. internet). The system bus 2102 facilitate is communication and moving data and instructions between the Processing unit 2104, the Memory 2106, the Display adapter and display devices 2110, the Input/output controllers 2112, and the Network interface controller 2108.

In the foregoing specification, the invention and its benefits and advantages have been described with reference to specific embodiments. However, one with ordinary skill in the art would appreciate that various modifications and changes can be made without departing from the scope of the present invention, as set forth in the claims. Accordingly, the specification and the figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

I claim:

1. A trusted social network platform for facilitating peer-to-peer shipment delivery, the trusted social network platform comprising:
a trip management module configured to receive details of a trip of a trusted traveler; and
a shipping information module configured to receive a package shipment request from a trusted shipper, wherein the trusted traveler and the trusted shipper have a pre-existing trust relationship through a trusted social network such that the trusted shipper is authorized to send package shipment requests for the trusted traveler;
a traveler-shipment matcher module configured to match the package shipment request with the trusted traveler to facilitate peer-to-peer shipment delivery; and
a reward management module configured to provide rewards to the trusted traveler wherein the rewards are based on one or more package shipments carried by the trusted traveler.

2. The trusted social network platform of claim 1 further comprising a trust network module configured to manage the trusted social network, wherein the trusted social network interconnects the trusted traveler and one or more trusted shippers.

3. The trust network module of claim 2 further comprising a social network interface module, the social network interface module configured to provide interface with a plurality of social media networks and to facilitate formation of the trusted social network by utilizing one or more social media connections of at least one of the trusted traveler and the trusted shipper.

4. The trust network module of claim 2 further comprising:
a trust network creation module configured to create the trusted social network; and
a trust network management module configured to update, delete and manage profile of the trusted traveler and the trusted shipper.

5. The trusted social network platform of claim 1, wherein the pre-existing trust relationship is based on at least one of from the group comprising a direct social association between the trusted traveler and the trusted shipper and an inherited social association between the trusted traveler and the trusted shipper, wherein the direct social association is established when the trusted traveler has a direct connection with the trusted shipper through a social media network, the direct connection being established when there is one degree of separation between the trusted traveler and the trusted shipper in the social media network, and wherein the inherited social association is established when the trusted traveler and the trusted shipper have an indirect connection through the social media network, the indirect connection being established when there is two or more degree of separation between the trusted traveler and the trusted shipper in the social media network.

6. The trusted social network platform of claim 1, wherein the pre-existing trust relationship is a provisional trust relationship, the provisional trust relationship is established when the trusted traveler temporarily adds the trusted shipper to the trusted social network of the trusted traveler.

7. The trip management module of claim 1 further comprising:
a trip submission module configured to receive, validate and save details of the trip;
a trip search module configured to search trips based on input parameters; and
a trip selection module configured to select a trip to place one or more package shipment request.

8. The trusted social network platform of claim 1 further comprising:
an account management module configured to manage member accounts of the trusted traveler and the trusted shipper;
a payment management module configured to process payments; and
a ratings module configured to manage ratings of the trusted traveler and the trusted shipper, wherein the trusted traveler is rated on the package shipment delivered and the trusted shipper is rated on the package shipment requested.

9. The trusted social network platform of claim 1 further comprising a green credit module configured to determine green credits earned by the package shipment delivery, wherein the green credits are based on the reduction in the energy usage achieved by the package shipment delivery facilitated by the trusted social network platform when compared to energy usage if the package shipment were delivered by a traditional shipment delivery service provider.

10. The trusted social network of claim 1, wherein the pre-existing trust relationship between the trusted traveler and the trusted shipper is established when a Trust Score (TS) is more than a predetermined value, wherein the Trust Score (TS) is assigned to the trusted shippers and measures the level of trust relationship between the trusted traveler and the trusted shipper.

11. The trusted social network of claim 10, wherein the Trust Score (TS) is based on at least one of an organizational score (OS), a social score (SS), an affinity score (AS), a rating score (RS), a transaction score (TXS), and a profile score (PS), wherein the organizational score (OS) is based on organizational association between the trusted traveler and the trusted shipper, the social score (SS) is based on social association between the trusted traveler and the trusted shipper, the affinity score (AS) is based on personal affinity between the trusted traveler and the trusted shipper, the rating score (RS) is based on ratings received by the trusted traveler and the trusted shipper, the transaction score (TXS) is based on the package shipments requests associated with the trusted traveler and the trusted shipper, the profile score (PS) is based on personal profile of the trusted traveler and the trusted shipper

12. The trusted social network platform of claim 1, wherein details of the trip comprises at least one of start location of the trusted traveler, start date of travel, end date of travel, end location of travel, and details of the package shipment.

13. The trusted social network platform of claim 1, wherein the reward management module if further configured to provide rewards to the trusted shipper based on a package shipment request placed by the trusted shipper.

14. A method for facilitating peer-to-peer shipment delivery in a trusted social network comprising, at a trusted social network platform:
receiving details of a trip of a trusted traveler; and
receiving a package shipment request of a trusted shipper, wherein the trusted traveler and the trusted shipper have a pre-existing trust relationship through the trusted social network such that the trusted shipper is authorized to send package shipment requests for the trusted traveler;
matching the package shipment request with the trusted traveler to facilitate peer-to-peer shipment delivery; and
providing reward to the trusted traveler wherein the reward is based on one or more package shipments carried by the trusted traveler.

15. The method of claim 14 further comprising managing the trusted social network, wherein the trusted social network interconnects the trusted traveler and the trusted shipper.

16. The method of claim 15 further comprising facilitating formation of the trusted social network by utilizing one or more social media connections of the trusted traveler and the trusted shipper.

17. The method of claim 14 further comprising:
validating details of the trip;
saving the details of the trip;
searching for the trip based on input criteria; and
selecting the trip to place a package shipment request.

18. The method of claim 14 further comprising:
managing member accounts of the trusted traveler and the trusted shipper;
processing payments for the trusted traveler and the trusted shipper; and
providing rating to the trusted traveler and the trusted shipper.

19. The method of claim 14 further comprising determining green credits earned by the package shipment delivery, wherein the green credits are based on the reduction in the energy usage achieved by the package shipment delivery facilitated by the trusted social network platform, when compared to energy usage if the package shipment were delivered by a traditional shipment delivery service provider.

20. A computer storage device encoded with a computer program, the program comprising instructions that when executed by a computational device cause the computational device to perform operations comprising:
receiving details of a trip of a trusted traveler; and
receiving a package shipment request from a trusted shipper, wherein the trusted traveler and the trusted shipper have a pre-existing trust relationship through a trusted social network such that the trusted shipper is authorized to send package shipment requests for the trusted traveler;
matching the package shipment request with the trusted traveler to facilitate peer-to-peer shipment delivery; and
providing rewards to the trusted traveler wherein the rewards are based on one or more package shipments carried by the trusted traveler.
